(19) United States
(12) Patent Application Publication
(10) Pub. No.: US 2002/0155807 A1
(43) Pub. Date: Oct. 24, 2002

(54) Device for controlling an air-moving apparatus upon activation of a smoke detector

(76) Inventors: Matthew C. Moor, Columbus, OH (US); John Harlan Bockbrader, Columbus, OH (US)

Correspondence Address: PORTER WRIGHT MORRIS & ARTHUR, LLP, INTELLECTUAL PROPERTY GROUP, 41 SOUTH HIGH STREET, 28TH FLOOR, COLUMBUS, OH, 43215

(21) Appl. No.: 09/683,987

(22) Filed: Mar. 8, 2002

Related U.S. Application Data
(60) Provisional application No. 60/274,625, filed on Mar. 12, 2001.

(51) Int. Cl. F24F 7/007; F24F 7/06; A62C 39/00

(52) U.S. Cl. 454/342

(57) ABSTRACT

A device that automatically disables an air-moving device if smoke is detected in a building by a smoke detector is disclosed in which a smoke detector and a control circuit that use signals generated by the smoke detector disrupts the current flowing through either the control or power wiring for the air-moving device. The device is hard wired or wireless and eliminates the distribution of smoke throughout the building by an air-moving device thus preventing unnecessary property damage, smoke inhalation and smoke-filled escape routes, saving money and lives.

### CROSS REFERENCE TO RELATED APPLICATIONS

This application claims the benefit of priority of U.S. Provisional Application No. 60/274,625, titled “The Automatic Disabling of a Forced Air Furnace or Other Air-Moving Device When the Presence of Smoke is Detected” and filed Mar. 12, 2001, incorporated by reference herein as if set forth in full.

### BACKGROUND OF INVENTION

This invention relates to the automatic control of an air-moving device if smoke is detected in a building, utilizing the combination of a smoke detection device and a control circuit.

In a typical fire in a building, a significant amount of property damage and human injury, including most fire-related fatalities, are caused by smoke. When a fire begins, the building's forced-air furnace or other air-moving device circulates the smoke and hot air that result throughout the rest of the structure. This is especially true when cold air returns and/or furnace air intakes are located near the ceiling where smoke tends to collect. When smoke is circulated throughout the structure, preventable smoke damage occurs to property. Circulating smoke creates difficulties for rescue personnel to pinpoint the location of the fire. Circulating smoke may also prevent people in the building from being able to breathe, see clearly to escape and survive.

The present invention automatically disables air-moving devices when smoke is detected within a structure thereby limiting the amount of smoke that may be circulated through the rest of the building.

Several existing patents use smoke detectors to turn off devices that actually cause or add fuel to a fire, but no system currently exists to prevent the circulation of smoke throughout a building in response to any smoke-related event. U.S. Pat. No. 5,670,074 to Kass provides an internal apparatus to shut off a furnace if the furnace catches fire, leaks fuel, or exhausts gases. Similarly, U.S. Pat. No. 4,659,909 to Knutson provides a system for shutting off an electric range when smoke is detected at the appliance itself. However, neither of these systems takes into account smoke from any other sources or locations throughout a building. Neither of these systems is designed to prevent the circulation of smoke throughout the building by any potential air-moving device.

U.S. Pat. No. 6,130,412 to Sizemore details a system that monitors its own remote sensors and turns off/on household appliances to prevent further fuel from being added to an existing fire. Sizemore does not address the problem of an air-moving device such as used with a forced air furnace or other HVAC cooling or heating device when smoke is present.

The present invention is designed to stop the unnecessary circulation of smoke by any air-moving apparatus during a fire. An advantage of the present invention is that the invention uses existing smoke detectors and smoke detection technology, rather than its own sensor array. Individuals around the world could use the proposed invention to retrofit or replace their existing smoke detectors cheaply and easily, preventing a potentially devastating circulation of smoke.

The principal object of the invention presented is to eliminate the possibility of smoke being distributed throughout a building by the operation of a forced air furnace or other air-moving or powered ventilation device such as air conditioners, evaporative coolers, attic fans, ceiling fans, airtight fireplaces, etc. The present invention works by automatically disabling the air-moving apparatus when smoke is detected within the building. This invention builds upon existing smoke detection capabilities to create a new device and method that may potentially save lives.

A smoke detector consists of a circuit that detects the presence of smoke and sends a signal to an alarm such as a siren, bell, whistle, or horn (herein a siren), which provides an audible notification that smoke is present. In the present invention the smoke detector also sends a signal (either the same signal sent to the siren or a separately generated signal) to a control circuit, which automatically disrupts the operation of an air-moving apparatus such as a forced-air furnace.

In the preferred embodiment, the current flowing from the air-moving apparatus to its control mechanism (i.e. thermostat or timer) will be disrupted automatically by the control circuit, preventing the apparatus from being activated while smoke is present. In situations where a control mechanism is not available, the current used to power the air-moving apparatus is disrupted directly by the control circuit. The control circuit consists of a relay that uses the signal supplied by the smoke detector to open or close the switches through which the power to the control mechanism or air-moving apparatus is routed.

The present invention includes the advantage of resumption of power to the control mechanism or air-moving apparatus when the smoke sensor no longer detects smoke in the structure. In cases where the fire is quickly contained, this feature allows automatic reactivation of the air-moving apparatus.

Three configurations of the invention with variations are described (one single smoke detector/control circuit unit and multiple smoke detector/control circuit units; both wireless and electrically connected): 1. A single smoke detector either AC or DC powered with one control circuit system. Power to the air-moving apparatus (or control unit) is disabled when smoke reaches the area containing the smoke detector. Systems, operating independently, may be placed throughout the building.

2. Stand-alone multiple smoke detectors, each with one control circuit system. The control unit (such as the furnace thermostat) wiring or power wiring for the air-moving apparatus is routed through the control circuit of each smoke detector. The air-moving apparatus is disabled when smoke reaches any area containing a smoke detector.

3. Interconnected multiple smoke detectors with one control circuit system. When one smoke detector in the system detects the presence of smoke, a signal is sent to all other smoke detectors (via a wire or wirelessly) closing the switch in the other smoke detectors and activating the siren. The control unit (such as the furnace thermostat) wiring or the air-moving apparatus” power wiring is routed through a single control circuit attached to one of the smoke detectors in the system or located remotely.

The use of multiple smoke detector systems (in configuration) is more likely to ensure that any unnecessary circulation of smoke is prevented. The more smoke detectors that are used, the more likely smoke will be detected prior to reaching any air-moving apparatuses and channels within the building.

### BRIEF DESCRIPTION OF DRAWINGS

FIG. 1 is a schematic drawing of a device for automatically controlling an air-moving apparatus with a smoke detector.

FIG. 2 is a schematic drawing of a device for automatically controlling an air-moving apparatus with multiple smoke detectors and control circuits.

FIG. 3 is a schematic drawing of a device for automatically controlling an air-moving apparatus with multiple interactive smoke detectors.

FIG. 4 is a schematic drawing of a wireless version of a device for automatically controlling an air-moving apparatus with smoke detectors.

FIG. 5 is a schematic drawing of a device for automatically controlling an air-moving apparatus with multiple interactive smoke detectors using a wireless configuration.

### DETAILED DESCRIPTION

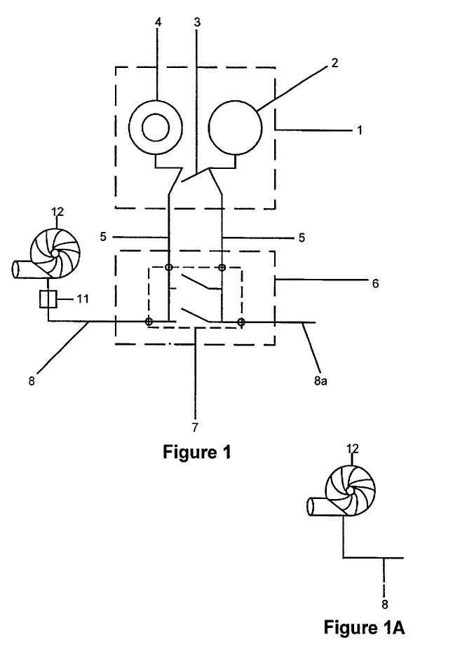

Referring to FIG. 1, the preferred embodiment employs a smoke detector 1 and a control circuit 6. When a smoke sensor 2, detects smoke, a switch 3 interconnected the smoke sensor 2 and a siren 4, is activated. Connected to the switch 3 are control wires 5, which are further connected to a relay 7 of a control circuit 6. In the open position, no current flows through the switch 3. When the switch 3 is closed, a signal is sent through the control wires 5 to the normally closed relay 7 connected to the control circuit 6. The relay 7 opens and disrupts the current flowing through the wires 8, 8a to the air-moving apparatus 1 2 control unit 11. The system may also be directly connected to the air-moving apparatus 12 as shown in FIG. 1A. The opened relay 7 disrupts the circuit and prevents the air-moving apparatus 12 from operating as long as smoke is detected by the smoke sensor 2. If the smoke sensor 2 no longer detects smoke, the switch 3 returns to the open position, closing the relay 7 and restoring the circuit to the air-moving apparatus 1 2 or the control unit 11.

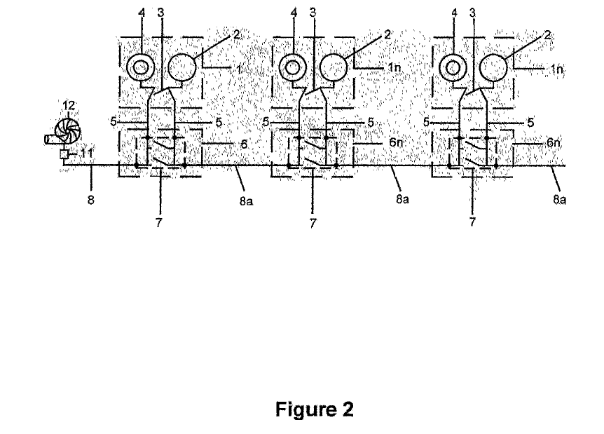

FIG. 2 shows multiple smoke detectors 1-1 n each with a control circuit 6-6n.

Each control circuit 6-6n is independently connected to a smoke detector 1-1n and additionally connected through wires 8, 8a traveling to the air-moving apparatus 12 in series. If any one smoke detector 1-1n is energized by a smoke sensor 2, a switch 3 sends current through wires 5 to open the relay 7 of the control circuit 6-6n to disrupt the current flowing through the wire 8 and deactivate the control unit 11 of the air-moving apparatus 12.

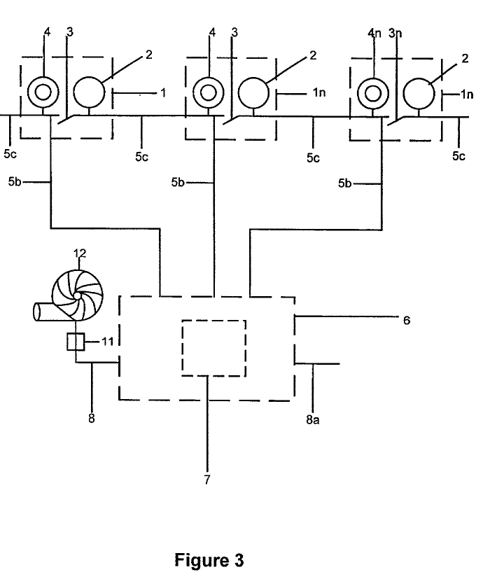

FIG. 3 shows a wired interactive system. In this system, any smoke sensor 2 detecting smoke closes the switch 3 of that smoke detector 1. The closed switch 3 sends a signal via a wire 5b to the relay 7 and via a wire 5c to a second smoke detector 1n. The signal closes the second smoke detector 1n switch 3n to activate a second siren 4n. The second smoke detector 1n in turn sends a second signal via a wire 5b-5bn to the relay 7 and via a wire 5c-5cn to an additional smoke detector 1n and the process repeats. The system shown in FIG. 3 is advantageous if a fire has destroyed the wiring of a smoke detector 1 leading to the control circuit 6.

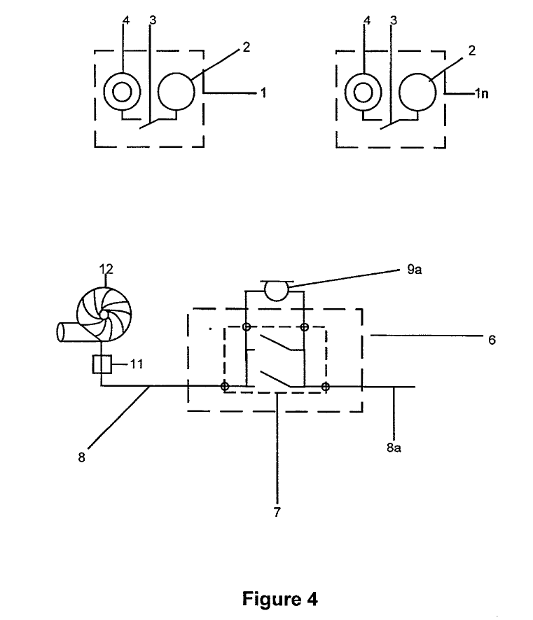

The control circuit 6 may also be remote from the smoke detector 1. As shown in FIG. 4, a control circuit 6 placed near one or more than one smoke detector 1-1n includes a microphone 9a connected to the relay 7 of the control circuit 6. When the siren 4 is activated, the microphone 9a hears the audible signal. The microphone 9a sends an output to the relay 7. The output opens the relay 7, disrupting the current flowing through the air-moving apparatus 12 control unit 11 or power wiring 8. When the smoke sensor 2 no longer detects smoke, the switch 3 opens, deactivating the siren 4, and the microphone 9a discontinues output to the relay 7. The relay 7 reverts to the closed position restoring the circuit to the air-moving apparatus 12.

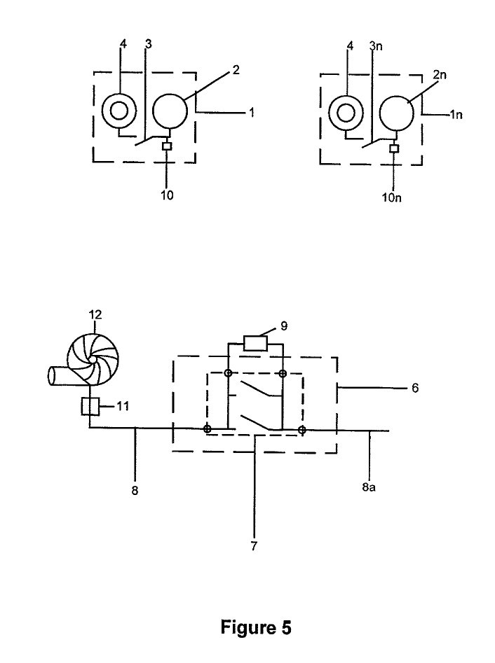

FIG. 5 depicts interactive smoke detectors in a wireless system. When smoke is detected by any smoke sensor 2-2n of one or more than one smoke detector 1-1 n, the switch 3-3n closes and sends a signal to an input/output component 10-10n interconnected to the switch 3-3n and the sensor 2-2n. The energized input/output component 10-10n sends a signal to a sensor 9 connected to the control circuit 6 and to a second input/output component 10-10n interconnected to one or more than one smoke detector 1-1n. The signal energizes the sensor 9 of the control circuit 6 and the sensor 9 sends an output to the relay 7 to open the relay 7. The opened relay 7 disrupts the current flowing through the air-moving apparatus 12 or control unit 11. The signal to the second input/output component 10-10n activates the switch 3n of that smoke detector 1-1n, which activates the siren 4n. The second input/output component 10-10n additionally sends a signal to the sensor 9 as well as to additional input/output components 10-10n and the process repeats.

Should the smoke sensor 2-2n no longer detect smoke, the input/output component 10-10n discontinues the signal to the sensor 9 and to the second input/output component 10-10n. The sensor 9 discontinues sending output to the relay 7, which closes the relay 7. The closed relay 7 restores the current flowing through the air-moving apparatus 12 or control unit 11.

The preferred embodiments herein disclosed are not intended to be exhaustive or to unnecessarily limit the scope of the invention. The preferred embodiments were chosen and described in order to explain the principles of the present invention so that others skilled in the art may practice the invention. Having shown and described preferred embodiments of the present invention, those skilled in the art will realize that many variations and modifications may be made to affect the described invention. Many of those variations and modifications will provide the same result and fall within the spirit of the claimed invention. It is the intention, therefore, to limit the invention only as indicated by the scope of the claims.

1. a device for controlling the operation of an air-moving apparatus by a smoke detector comprising:
one or more than one smoke detector having a switch, the switch moveable between from an open position to a closed position and interconnected to a smoke sensor and a siren, the switch moveable to the closed position upon a detection of smoke by the smoke sensor; the closed position of the switch being a mechanism that activates the siren to produce an audible signal;
a control circuit disposed between the smoke detector and an air-moving apparatus, the control circuit interconnected to the air-moving apparatus, the control circuit having a relay, the relay moveable between from a closed to an open position upon activation, the open position of the relay being an interrupt to an electrical current powering the air-moving apparatus.

2. The device of claim 1 wherein the electrical current commands a control unit connected to the air-moving apparatus.

3. The device of claim 1 wherein the control circuit is disposed between the one or more than one smoke detector and the air-moving apparatus by a control wire such that the closed position of the switch activates the relay.

4. The device of claim 4 wherein a plurality of control circuits are interactively connected.

5. The device of claim 1 wherein a plurality of smoke detectors are interactively connected such that a closed switch in a first smoke detector further provides a signal to a second smoke detector, the second smoke detector switch being closed by the signal, the closed switch activating the relay.

6. The device of claim 1 wherein the control circuit is remote from the one or more than one smoke detector and further includes a control circuit sensor, the control circuit sensor operatively interconnected to the relay, the control circuit sensor capable of remote activation, the activated control circuit sensor including a mechanism to activate the relay.

7. The device of claim 6 wherein the control circuit sensor is a sound sensor capable of remote activation by the audible signal of the siren.

8. The device of claim 6 further including an input/output component operatively connected between the smoke sensor and the switch, the input/output component being activated by the closed position of the switch, the activated input/output component sending a signal to the control circuit sensor and to a second input/output component; the control circuit sensor signal energizing control circuit sensor to activate the relay, the second input/output component signal energizing the second input/output component to close a second switch.

9. A device for controlling the operation of an air-moving apparatus by a smoke detector comprising:
one or more than one smoke detector having a switch, the switch moveable between from an open position to a closed position and connected to a smoke sensor, the switch moveable to the closed position upon a detection of smoke by a smoke sensor; the closed position of the switch being a mechanism that activates a siren operatively connected to the smoke detector to produce a siren signal, the smoke detectors interactively interconnected such that the closing of a first switch allows electrical current to additionally flow to a second switch;
a control circuit connectivity wired between one or more than one smoke detector and an air-moving apparatus, the control circuit having a relay, the relay moveable between from a closed position to an open position upon activation by an electrical signal, the electrical signal being produced by one or more than one closed switches, the open position of the relay preventing an activation of the air-moving apparatus, the relay closing in the absence of the electrical signal.

10. A device for controlling the operation of a ventilation apparatus by a smoke detector comprising:
one or more than one smoke detector having a switch, the switch moveable between from an open position to a closed position and connected to a smoke sensor, the switch moveable to the closed position upon a detection of smoke by a smoke sensor; the closed position of the switch being a mechanism that activates a siren operatively connected to the switch to produce a siren signal, the closed position of the switch being a further mechanism that activates an input/output component disposed between the switch and the siren; the activated input/output component capable of remotely sending a signal to a second input/output component and to a control circuit sensor interconnected to a relay in a control circuit;
the control circuit remote from the one or more than one smoke detector and interconnected to an air-moving apparatus, the control circuit sensor capable of receiving a signal from a plurality of input/output components, the signal activating the control circuit sensor to send an electrical signal to the relay, the relay moveable between from a closed position to an open position upon receiving the electrical signal, the open position of the relay preventing an activation of the air-moving apparatus, the relay closing upon the absence of the electrical signal.

11. A method for controlling the operation of an air-moving apparatus by a smoke detector comprising:
(a) disposing a control circuit between one or more than one smoke detector and a circuit of an air-moving apparatus;
(b) activating a smoke sensor in the smoke detector with smoke;
(c) closing a switch in the smoke detector;
(d) powering a siren in the smoke detector;
(e) producing a siren signal;
(f) opening a relay in the control circuit; and,
(g) interrupting an electrical current powering the air-moving apparatus.

12. The method of claim 11 wherein opening the relay comprises a step selected from the group consisting of (1) sending an electrical signal produced by a plurality of closed switches over a wire connecting the relay and the switch, (2) sending an electrical signal to the relay from a control circuit sensor capable of receiving and being energized by the siren signal, and (3) sending an electrical signal to the relay from a control circuit sensor capable of receiving and being energized by a plurality of input/output components activated by a plurality of closed switches.
